(19) United States
(12) Patent Application Publication
(10) Pub. No.: US 2023/0264308 A1
(43) Pub. Date: Aug. 24, 2023

(54) CENTRAL TOOL STORAGE DEVICE

(71) Applicant: DECKEL MAHO Pfronten GmbH, Pfronten (DE)

(72) Inventors: Robert JUNG, Pfronten (DE); Michael TRENKLE, Pfronten (DE)

(21) Appl. No.: 18/024,026

(22) PCT Filed: Sep. 16, 2021
(86) PCT No.: PCT/EP2021/075463

§ 371 Date: Feb. 28, 2023

(30) Foreign Application Priority Data
Sep. 17, 2020 (DE) 10 2020 211 672.5

(51) Int. Cl. B23Q 3/155; B23Q 7/04

(52) U.S. Cl. CPC B23Q 3/15539; B23Q 7/046; B23Q 2003/15528

(57) ABSTRACT

The present invention relates to a central tool storage device WL with a tool storage S, containing a plurality of wheel magazines S3 positioned one behind the other, a movable manipulator S12 as well as a provisioning station S4 provided with a movable provisioning bar S4 and a mobile transport unit E, which, for providing tools W for a machine tool WM spaced apart, removes a tool W from the wheel magazines with the aid of the manipulator S12 and transfers it via the provisioning bar S4 to the provisioning station S2 of the mobile transport unit E to transport it to the respective machine tool WM without a guide or track, and which, for storing tools W received from at least one machine tool WM, transfers the tool W via the mobile transport unit E to the provisioning bar S4 of the provisioning station S2 and removes it from the provisioning bar S2 with the aid of the manipulator S12 and adds it to a wheel magazine S3 of the tool storage S.

The present invention relates to a central tool storage device with a tool storage consisting of wheel magazines for tool changes with one or more machine tools, in which the tool to be changed can be transported at least partially automatically by a freely movable mobile transport unit from the tool storage to the respective machine tool and back.

### BACKGROUND OF THE INVENTION

Generic tool storage devices known from the prior art for storing or provisioning tools from and for machine tools usually comprise one or more tool magazines, realized by a shelf system or by any other ordered tool holding devices fixing a plurality of tools, by a holding mechanism integrated in the tool magazines for fixing and positioning the tools in the respective tool magazine, as well as by a movable changing device enabling tool changes between the tool magazines and the machine tool.

EP 0144912 A2 shows a tool storage device for a milling and drilling machine, which provides tools in a horizontally mounted radial magazine and is connected to a tool spindle of the machine tool via a slide rail. A gripper head, which is movable on the slide rail, further enables the removal, delivery and transport of the tools from and to the radial magazine and the work spindle.

DE 102011082050 A1 also shows a tool changing system for changing and inserting or preparing tools on a machine tool, which also includes a rotatable wheel magazine mounted in a vertical direction. The tools are held in the wheel magazine along their longitudinal axis in such a way that a large part of their bodies protrude radially from the wheel magazine, and thus, can be removed by a manipulator which is also included in the system. The manipulator is also mounted on linear guide rails that can be moved in a horizontal plane so that tools removed from the wheel magazine can be transported to the machine tool and tools received from the machine tool can be returned to the wheel magazine.

Due to their ability to store a large number of tools and, if necessary, to make them available to the respective machine tool in an fast manner and, in most cases, automatically by means of a tool changing device, current tool storage devices already have a high value for the increasingly complex sequences at today's machine tools, which require more and more tools for machining.

However, in case of prior art tool storage devices, the problem arises that in most cases the tool storage can no longer be used efficiently, especially due to the increasing number of tools to be stored. For example, a tool storage device usually stores a large number of tools for only one or at least for a few machine tools, resulting in unnecessary storage times and additional costs due to the multiple acquisition of corresponding tools. On the other hand, experience has shown that large-scale centralization of today's tool storage facilities also turns out to be quite challenging, in particular because the corresponding tool transport and change paths shortly become inefficient due to the mostly rigid and in many cases mutually interfering connecting elements between tool storage facilities and several machine tools (see e.g., the slide rail in EP0144912A2).

It is therefore a task of the invention to provide a tool storage device that is as central as possible and a method for changing tools by means of a central tool storage device, which solve the aforementioned problems from the prior art and which make it possible to distribute stored tools to a plurality of machine tools as efficiently and simplified as possible or to store tools from a plurality of machine tools. In addition, it is a task to optimize the structure of the central tool storage device in such a way that the area occupied by the tool storage device can be used as optimally as possible in relation to the above-mentioned efficiency of the tool changes.

### DETAILED DESCRIPTION OF THE INVENTION

To solve the above problem, the features of the independent claims are proposed. The dependent claims relate to preferred embodiments of the present invention.

The central tool storage device for tool provisioning for a plurality of machine tools can comprise a tool storage consisting of at least two wheel magazines arranged vertically, parallel and one behind the other, in which tools can be placed in radially aligned tool holding locations integrated in the wheel magazines and which are securely fixed, protected from slipping off due to gravity, respectively, by a holding mechanism. For an effective removal and storage of tools in the tool storage, a manipulator can also be arranged, preferably adjacent to the outer surface of the wheel magazines, which is preferably movable parallel to the common rotation axis of the at least two wheel magazines, and thus, can remove tools for tool provisioning from the tool holding locations of the wheel magazines or position them for storage in the tool holding locations, and also enables to transport them along the above-mentioned axis. Furthermore, for an efficient tool change with one or more machine tools, the tool storage device can provide at least one mobile transport unit, which is freely movable between the tool storage device and the machine tool, as well as at least one provisioning station, which is used for providing tools for the tool storage device and the mobile transport unit. In the present case, the tool storage device can preferably be configured such that, for transferring a tool from the tool storage device to a machine tool, the provisioning station can first pick up at least one tool, having been removed from the wheel magazines by the manipulator, and make it available to the mobile transport unit. Following this, the mobile transport unit can transfer the tool provided by the provisioning station to itself by means of a transfer device integrated on the mobile transport unit and transport it to the machine tools without any rails, i.e., without further waiting times caused by an extensive rail network. Similarly, the process can preferably also be controlled in reverse for storing tools in the tool storage, so that the mobile transport unit is able to take tools from one or more machine tools and make them accessible to the tool storage by transporting them and transferring them to the provisioning station. Furthermore, the manipulator can preferably also pick up tools transferred by the mobile transport unit, e.g., from the transfer device of the provisioning station, and, for efficient storage, add them to the free tool holding locations of the wheel magazines.

Thus, this design of a central tool storage device provides an efficient and at the same time cost-saving method for providing and storing tools, especially for and from a plurality of machine tools. In particular, transferring and transporting the tool by the at least one freely movable mobile transport unit realizes a simpler and at the same time faster method of providing tools for a larger number of machine tools compared to the state of the art: Due to the free movement of the mobile transport unit, individual tool transfers and transports, for example, have no longer to be carried out one after the other, as it is the case with a central rail system, but can be carried out independently and in parallel, e.g. by several mobile transport units operating simultaneously. This also has the consequence that, on the one hand, process waiting times, in particular tool storage times, in a central tool storage device can be considerably reduced, and thus, tools can be used more efficiently and costs can be saved, as no additional tools and tool storage devices are required. On the other hand, the mobile transport unit of the tool storage device has the further advantage that the tool change can be carried out independently of the number of tool storage devices and machine tools, and preferably fully automatically. In contrast to systems with rail or similar guiding devices, in tool storage systems with mobile transport units, further tool storage units or machine tools can simply be added or removed modularly without having to observe an already existing, complex guiding network. Ultimately, the working space to be used for the respective tool storage devices and machine tools can also be optimally utilized by the tool storage device presently shown.

In order to ensure the protection of workers and stored tools or storage elements during the changing process, the tool storage, preferably both, the wheel magazines and the manipulator, can be surrounded at all times from at least two sides by a base frame provided with walls. Preferably, the base frame can enclose the entire tool storage device and reach at least beyond the highest wheel magazine enclosed on the inside, so that workers standing outside can be fully protected, even during a possible malfunction of the tool storage device. In addition, the base frame as well as its walls can be made of light metal, hardened plastic or other light and resistant materials, and the walls can preferably be attached to the base frame in one piece by screw, tongue-and-groove or other removable connection techniques. The latter has the advantage that for adding or removing further wheel magazines within the tool storage, the area enclosed by the base frame can easily be modified, and thus, optimally adapted to the storage area required.

Preferably, the wheel magazines located within the area enclosed by the base frame can also be positioned with their longitudinal axis parallel to one of the base frame walls, and in a particularly preferred embodiment, parallel to the rear or front wall of the base frame. In other words, the wheel magazines can be hold upright and are arranged one behind the other, preferably from the front to the rear wall of the base frame, being able to achieve maximum compactness of the tool storage. The arrangement of the wheel magazines can be further ensured by bearings arranged in a row at defined intervals, for example by a centrally located radial bearing or by a three-point bearing located on a triangular frame, wherein a wheel magazine can always be detachably fixed for possible removal or replacement to another tool storage. Here, of course, the mounting of the individual wheel magazines is not limited to a single-point or three-point bearing system, but can equally be realized, for example, by a four-point or multi-point bearing system. Furthermore, the frames holding the respective bearings can additionally be connected to elements of the base frame or to already existing bearing frames, which ensures a stable hold of the wheel magazines and allows them to be used as an extension to an existing tool storage system.

The tool holding locations of each wheel magazine of the tool storage can preferably be arranged uniformly and radially around the rotation axis of the respective wheel magazine, i.e., the holding locations to be used for inserting the tools point, preferably, parallel to the radial vector of the corresponding wheel magazine at all times. This has the advantage that tools inserted later can also be fixed along their longitudinal axis in the radial direction, and thus, be inserted compactly into the storage. Likewise, releasable holding mechanisms, such as a detent connection, a pawl mechanism or a coupling mechanism, can be integrated in the tool holding locations such that the stored tool remains positioned firmly within the tool holding location during storage and particularly in case the wheel magazine is moved, while allowing also a simple release of the mechanism for providing the tool.

In a particularly preferred embodiment, the individual wheel magazines can also be rotated independently of one another and preferably hold a tool in such a way that during storage at least part of the stored tool, the so-called tool interface, is exposed as a removal section for the manipulator. In this way, a simple possibility for the removal of a tool by the manipulator can be realized, while at the same time defining a tool area according to which the received tool can be identified before inserted into the tool storage or into the machine tool transfer, for example by means of an additional sensor.

Preferably, the above tool interfaces may correspond to a hollow shank taper, a steep taper, or a Morse taper.

Preferably, the manipulator can be arranged within the area encompassed by the base frame, particularly preferably, laterally along the rotation axis of the wheel magazines arranged one behind the other, wherein, in particular, the distance between the manipulator and the tool holding locations of the respective wheel magazines can be minimized, and thus, also the manipulators travel time during tool pick-up/delivery. In addition, the manipulator is preferably movable on a linear axis, for example by means of a pneumatically, electrically or mechanically controllable linear guide rail, running parallel to the rotation axis of the associated wheel magazines, so that the manipulator can be positioned directly in front of the wheel magazine to be used for the removal or transfer of tools, thus, operating with maximum efficiency.

Furthermore, the use of the linear guide rail has the advantage that the costs as well as the duration of the tool change can be further minimized. For example, in a fully automated embodiment of the wheel storage and the movable manipulator, both elements can be timely moved or positioned in parallel during the tool change process in such a way that significant time advantages can be gained compared to conventional tool magazine equipment, such as shelf magazines equipped with linear guides. Similarly, the degrees of freedom gained by the parallel process can also be used to further simplify the structure of important, usually cost-intensive elements, such as the manipulator, and thus, reduce the provisioning expenses for a tool storage to a minimum. In a particularly preferred embodiment, for example, the manipulator can be designed merely as a one-dimensional manipulator aligned parallel to the wheel axis of the radial magazines and movable in rotation, so that costs can be significantly reduced compared to the installation of more complex manipulators without significantly affecting the efficiency of the tool change process.

In addition, the manipulator preferably comprises at least one gripping device provided on a movable pivoting arm for removing or transferring tools from and to the wheel magazines or the provisioning station of the tool storage device, which can have at least one manipulator receptacle for simultaneous transport of tools removed from the wheel magazines or from the provisioning station. Preferably, the gripping device can be designed as a double gripper or as an interchangeable gripper provided with several receptacles, which can grip the tools of the tool magazine or of the provisioning station at the exposed tool interface. Preferably, the gripper picks them up or inserts them from or into the tool holding locations by a pivoting or by rotating movement and safely stores them within the manipulator receptacles during the process of the manipulator.

In a particularly preferred embodiment, a sensor for analyzing the tool to be changed can also be mounted on the manipulator. The sensor can, for example, be an optical, acoustic or mechanical sensor and consist of several elements, such as a camera together with additional analysis software. The advantage of such a sensor is that the condition of the tools to be stored or to be supplied can be checked before the actual tool change process, so that worn or defective parts can be effectively sorted out. Similarly, a sensor can be used to confirm the correctness of the tool that has been removed or is to be provided, so that an effective and reliable safety check can be made during the tool change process.

Preferably, the manipulator can further be configured, for providing or for storing tools for or from a machine tool, to be moved by means of the linear guiding device, at least back and forth from a first change position for tool change with the provisioning station of the tool storage device to at least a second change position for tool change with at least one of the wheel magazines, which are arranged one behind the other. Thereby, the traversing process can preferably be carried out automatically, and thus, enables an efficient exchange of tools between the tool storage device and the provisioning station of the tool storage device.

Thus, with help of the manipulator, an optimal intermediate component can be found which can remove tools required by a machine tool from the at least two wheel magazines of the tool storage and transfer them to the provisioning station for further provisioning to the mobile unit or which can pick up tools received from the mobile unit at the provisioning station and add them to the wheel magazines. Particularly preferably, this process can be realized, for tool provisioning for the machine tools, such that the manipulator moves through the linear guide device into at least the first change position and removes the required tools from the tool holding locations of the wheel magazines by means of its integrated gripping device via a lifting movement. Then, the manipulator can preferably move to the first change position, with the tools to be used always firmly fixed in the corresponding manipulator receptacles of the gripping device, and transfer the tool to the provisioning station by using the gripping device again, e.g., by releasing the tools from the manipulator receptacles. Vice versa, however, the manipulator can also be brought into the first change position for the storage of tools in the tool storage, so that in this case the tool provided by the provisioning station can be picked up by the gripping device and added to the tool storage by the manipulator through the subsequent transport to the first change position and the positioning of the tool in the respective tool holding locations of the wheel magazines.

For transferring or removing the tool between the manipulator and the provisioning station, the provisioning station can preferably comprise a movable provisioning bar, which can also be a tool provisioning bar. Preferably, the provisioning bar can position tools on the provisioning bar by means of at least one integrated provisioning bracket, and thus, optimally present the tool to the manipulator or present an optimal transfer position for transferrin it to the provisioning bar. For fixing the tools within the provisioning bar, the provisioning brackets can preferably include holding devices, similar to the previously mentioned holding mechanisms of the wheel magazines, so that tools transferred to the provisioning bar can be rigidly and securely held, while at the same time a simple release is ensured in the event of a tool transfer.

Similarly, the at least one provisioning bracket can preferably be configured in such a way that, when tools are picked up, it also exposes a tool interface, preferably the same as that applicable in the tool holding locations of the wheel magazines, and this can be used equally for picking it up by the manipulator, but also by other elements, such as the mobile unit. In particular, the latter has the advantage that a tool interface defined in the same way in all process steps would result in a clearly described interaction surface of the respective tool with the individual transfer devices, enabling a more precise positioning of the tools, for example for further sensors used to analyze the tools, and thus, the tool change process is further optimized.

In a particularly preferred embodiment, the provisioning bar is furthermore movable at least between a first position for tool change with the mobile unit and a second position for tool change with the manipulator positioned at the tool storage. This ensures optimal provision of the tools from the tool storage for the mobile unit or of the tools from the mobile unit to the respective tool storage, and further compensates for any height differences between the pick-up position of the mobile unit and that of the manipulator.

Preferably, the provisioning bar can therefore be movable, in particular vertically, wherein the provisioning bar can be arranged for this purpose on a provisioning guide, such as a chain or rail guide, and thus, remain precisely and controllably movable between the above-mentioned change positions via the movement of the provisioning guide.

Similarly, in a particularly preferred embodiment, for optimal receiving and holding the tools for the manipulator, the provisioning bar can be pivoted or rotated in the direction of the manipulator at least in the second change position, wherein any differences in the tool holding angle of the manipulator or the wheel magazines relative to the mobile unit can be optimally corrected, and thus, the latter elements can be given greater leeway with regard to their design and positioning within the tool storage device.

Preferably, the transfer angle of the provisioning bar resulting from the pivoting or rotating of the provisioning bar can correspond to a rotation angle of 45° to 120°, in a particularly preferred example between 80° to 110°, in the direction of the manipulator, wherein the transfer angle specified here is the angle of change of the provisioning bar from its original position, i.e. the position in which the provisioning bar is moved in the second position, preferably still having the same orientation as within in the first position, and the transfer position to be used for the tool change with the manipulator, i.e., the position in which the provisioning bar is moved in the second position, preferably still having the same orientation as for example in the first position, and the handover position to be used for the tool change with the manipulator. In an equally preferred case, the rotation axis of the transfer angle can also be located orthogonally to the surface of the provisioning station, so that the tool to be changed can only be rotated parallel to the provisioning station, and thus, cannot be damaged by elements of the provisioning station even in the event of any malfunctions.

Furthermore, the provisioning station of the tool storage device can preferably be positioned at the front and/or rear of the tool storage device and be aligned together with the provisioning bar orthogonally to the rotation axis of the wheel magazines. In other words, the longitudinal axis of the provisioning station can be designed parallel to the longitudinal axis of the individual wheel magazines, so that the basement of the wheel magazines, the movement of the manipulator and the longitudinal axis of the provisioning station or of the provisioning rail can be aligned with each other by a multiple of 90° alone. In particular, such a design makes it possible to construct efficient, i.e., fast, process sequences, wherein the area occupied by the tool storage device can be reduced to a minimum.

Preferably, the provisioning station may further comprise an entire side of the tool storage device, in which the provisioning bar including the provisioning guide may be arranged centrally at the provisioning station. Furthermore, in a particularly preferred embodiment, the provisioning station can comprise at least one alignment section for precise positioning of the mobile transport unit in a transfer position near the provisioning station, so that for tool change with the provisioning bar in the first position, the mobile transport unit must first be moved to the alignment section before a transfer or removal of a tool can be initiated with the aid of the mobile transport unit. Such an embodiment allows mobile transport units to be precisely positioned at the respective provisioning station, which only optimizes the accuracy and speed of the tool change process between the provisioning station and the mobile transport unit as well as additionally stabilizes the mobile transport unit, especially when transferring heavy tools.

For example, in a preferred embodiment, the mobile transport unit may further connect itself to the alignment section through an alignment interface arranged on the mobile transport unit, wherein the connection may be established mechanically, such as by means of a positive locking element, electrically, or in other reopenable ways. In addition, the connection between the alignment section of the provisioning station and the alignment interface of the mobile transport unit can be configured to block any movement of the mobile transport unit, in particular along the longitudinal axis of the provisioning station, thereby preventing displacement of the mobile transport unit, which would damage it, and further stabilizing the weight distribution on the mobile transport unit during the tool changing process.

Furthermore, the mobile transport unit can preferably be configured to receive a signal from the provisioning station, for example electrically by means of induction or optically, while positioning the alignment interface to the alignment section of the provisioning station, wherein the transfer or removal of the tool to the provisioning rail can be initiated for the mobile transport unit. In particular, such a signal path enables an additional safety function of the tool change process, so that in case of an incorrect positioning of the mobile transport unit, especially in automatic operation of the tool storage device, the tool transfer can be stopped, and preferably, after a certain time an error message can be issued.

For the tool change with the provisioning rail, the mobile transport unit can preferably comprise a transfer device, which in turn has at least one movable transport bar, which can also be a tool transport bar, with a plurality of transport brackets for supporting the tools on the mobile transport unit and at least one gripping section for gripping the tool during the tool change. In this context, the transfer device can preferably be movable in the transfer position of the mobile transport unit at least in the direction of the provisioning station, i.e., in a particularly preferred embodiment horizontally in the direction of the provisioning rail, as well as in the vertical direction, having a vertical rotation axis. Such an amount of degrees of freedom can realize an efficient method for picking up or transferring tools at the provisioning rail.

In a preferred embodiment, the mobile transport unit first aligns itself frontally to the alignment section of the provisioning station with the alignment interface, preferably in the direction of the provisioning station, wherein the mobile transport unit is precisely positioned in the transfer position. In a next step, the transfer device of the mobile transport unit can then move the tool transport bar together with the gripping section and any tools to be stored in the direction of the provisioning bar, depending on the tool change process, so that the gripping section or the tools to be stored are ultimately positioned at the respective provisioning brackets of the tool provisioning bar. In this context, the gripping section can be designed in such a way that it transports each tool to be changed individually, for example by means of a multi-dimensionally movable manipulator arm, or simultaneously transports all the tools placed in the tool transport bar. In a particularly preferred embodiment, the gripping section can be coupled to the transport brackets of the tool transporting bar in such a way that each transport bracket comprises an individual, separately controllable gripping element, wherein, by positioning the tool transporting bar above the provisioning brackets of the tool provisioning bar, only selected tools can be simultaneously removed or transferred.

Then, the tool to be stored can be inserted through the gripping section into the provisioning bracket at the tool interfaces, preferably via vertical approaching the provisioning bracket (from below the transport bar). Thus, the removal stroke/pick-up stroke is performed by the input bar of the central tool storage device or the machine tool. In a preferred further development, only the transport bar can also approach the provisioning bar vertically from above, or in a particularly preferred further development, the provisioning bar and the transport bar can approach (for example, simultaneously). For the provision of tools for a machine tool, the aforementioned transfer process can be carried out in reverse, and thus, be used to remove a tool from the provisioning bar and transfer it to the transport bar of the mobile transport unit. Preferably, the transfer device can comprise transport bars located on several sides, so that the transport bars to be used for tool change can be varied quickly and efficiently within the tool change process by a simple rotation of the transfer device. In a final step, the transfer device can preferably return to its original position after the tool change, wherein tools taken over for provisioning them to a machine tool can be fixed in the transport brackets, and thus, being secured for transport to the respective machine tool. Similarly, the tool interface can be configured in such a way that the connection with the alignment section of the provisioning station can be released by moving the transport bar back to its original position, thus, enabling the mobile transport unit to move freely in the direction of the next target, in particular of a machine tool or of another tool storage device.

For the free transport of the tools to be changed from the tool storage to at least one machine tool and back, the mobile transport unit can preferably comprise a trackless floor conveyor, for example a forklift, an automated lift truck or another freely movable vehicle device equipped with at least one fork, wherein the transfer device of the mobile transport unit is preferably mounted on this floor conveyor in a connectable and removable manner. Such an embodiment has in particular the advantage that, depending on the nature of the machine tool storage system, the transfer device can be decoupled and transferred, for example, from a manual to an automated floor conveyor. For the realization of the latter case, moreover, the floor conveyor or the mobile transport unit can likewise comprise a control device for driverless or automated control of the mobile transport unit and/or a communication device which is connected to an external control device, for example, via a wireless connection, such as W-LAN, Bluetooth or infrared signals.

Thus, the tool storage device described here represents a possibility of providing tools, in particular for a plurality of machine tools, in an extremely dynamic and efficient manner. On the one hand, the combination of independently rotatable wheel magazines with a manipulator that can be moved parallel to the tool storage has the advantage, compared to conventional tool magazines, like shelf magazines, that the storage and removal of the tool at the respective wheel magazine can be carried out much more quickly and in parallel, reducing unnecessary waiting times during the tool change. On the other hand, a larger number of tools can be transferred at the same time due to the plurality of provisioning or transfer holders at the provisioning station and the mobile transport unit, so that the tool change turnover is increased, and respective elements themselves can be preloaded in idle times, and thus, being efficiently prepared for the further process steps.

In addition, the tool change and transport by means of a freely movable mobile transport unit offers the great advantage of being able to position the respective tool storage device centrally. In other words, in a particularly preferred embodiment, the tool storage device to be used can be positioned (completely) independently of any machine tool and in particular at a distance from it, so that a large number of machine tools can be served as optimally as possible. On the other hand, however, especially with regard to a system provided with a plurality of machine tools and tool storage device, the independent positioning of the machine tools and/or the tool storage device allows the space occupied by these elements to be used as modularly and effectively as possible.

In a particularly preferred embodiment, the tool storage device can also be configured in such a way that the entire tool change process, i.e., from the transport of the tool from or to the machine tool to its storage or its transfer to the tool storage device, can be fully automated, further increasing the efficiency of the entire process. In this case, the processes of individual elements of a tool storage device can be parallelized and, in particular, synchronized, for example by an external control module, and the entire assemblies of tool storage device and machine tool can be made interoperable. In a particularly preferred embodiment, for example, the tool storage devices can be configured in such a way that they can request the tools required next by a machine tool in advance, preferably via a central network system, and thus, provide them before they are about to be used. Similarly, the mobile transport unit can preferably, for example, request the tool requirements of a machine tool in advance through the network system and compare them with the tool inventory of the individual tool storage devices or can look at the provision time of the tool storage devices, so that the movement of the mobile transport unit from the machine tool to the tool storage device and back can be optimally adapted. Preferably, the wheel magazines, the manipulator, the provisioning station and the mobile transport unit of the tool storage device can also communicate with the machine tool and with each other in order to make the tool change process as efficient as possible.

Preferably, through the connection of the alignment section to the alignment interface of the mobile transport unit, the provisioning station can further obtain tool data relating to the tools to be transferred from the mobile transport unit or required by at least one machine tool, for example via inductive transmission between the alignment interface and the alignment section or likewise through the central network system, and transfer them, in a particularly preferred embodiment, to an internal data memory.

Furthermore, the provisioning station can preferably be configured in such a way that it can compare the tool data received with a tool inventory of the tool storage device, preferably contained in the internal data memory and, in case the tool is found in its own tool inventory, controls the wheel magazine containing the required tool, the manipulator and the provisioning rail of the provisioning station for tool provisioning, in order to transfer the required tool from the wheel magazine to the mobile transport unit. Similarly, in the case of a tool received from the mobile transport unit for storage in the tool storage, it may preferably be possible for the respective provisioning station to include the tool data of the respective tool in the tool inventory, and controls the wheel magazine, the manipulator and the provisioning rail to transfer the tool received to the respective tool holding location provided for this purpose.

For more precise observation and control of the at least partially automated tool changing process, the provisioning station can preferably comprise at least one control unit provided with a display, wherein a worker can, for example, view the current tool inventory of the wheel magazines, the tool quality of the individual tools detected by the sensor integrated on the manipulator or the next process sequences through said control unit. In a particularly preferred embodiment, a control console on the control unit can also be used to manually control the pickup or transfer of tools, so that even in automated operation, for example in the event of error messages or in case tool samples are removed from the tool storage, the tool change process can be manually controlled or continued. It is also possible to switch between manual and automated operation via the control console or to run them in parallel so that, depending on the requirements, a manually controlled mobile transport unit, can be integrated into an automatic tool changing system.

### BRIEF DESCRIPTION OF THE FIGURES

FIG. 1A: shows a first, three-dimensional view of the tool storage device according to the invention including the mobile transport unit with the mobile transport unit in the transfer position.

FIG. 1B: shows the tool storage device of FIG. 1A with the transfer device of the mobile transport unit approaching the provisioning bar of the provisioning station.

FIG. 1C: shows the tool storage device of FIG. 1A with the transfer device of the mobile transport unit after tool removal and rotated about an angle of 45°.

FIG. 1D: shows the tool storage device of FIG. 1A with the transfer device of the mobile transport unit after tool removal and after rotation.

FIG. 2A: shows a manually movable embodiment of the mobile transport unit.

FIG. 2B: shows another embodiment of the mobile transport unit.

FIG. 3A: shows a detailed view of the provisioning station of the tool storage device.

FIG. 3B: shows detail view of provisioning station bar.

FIG. 4A: shows the mobile transport unit of the 2B transferring tooling to the provisioning bar of the provisioning station, with the transfer device of the mobile transport unit aligned with the alignment section of the provisioning station.

FIG. 4B: shows the transport unit provisioning bar system of FIG. 4A, wherein the provisioning bar has been moved vertically under the aligned transfer device.

FIG. 4C: shows the transfer unit provisioning rail system of FIG. 4B, with the aligned transfer device moved horizontally in the direction of the provisioning rail.

FIG. 4D: shows the transport unit provisioning bar system of FIG. 4C, where the provisioning bar has been moved vertically upwards in the direction of the transport bar for inserting the tools stored in the transfer device into the provisioning brackets.

FIG. 4E: shows the transport unit provisioning bar system of FIG. 4D, with the transfer device moved horizontally away from the provisioning bar after the tools have been positioned.

FIG. 5A: shows the tool storage device of Fig. IA without walls and mobile transport unit.

FIG. 5B: shows the tool storage device illustration of FIG. 5A rotated.

FIG. 6A: shows the tool storage device illustration of FIG. 5B with walls, but with opened transfer side of the provisioning station.

FIG. 6B: shows the tool storage device illustration of FIG. 6A rotated.

FIG. 7A: shows the tool storage device illustration of FIG. 5A with the provisioning bar in the second position and pivoted in the direction of the manipulator.

FIG. 7B: shows the tool storage device illustration of FIG. 7A rotated.

FIG. 8A: shows the tool storage device illustration of FIG. 7A with walls, but with opened transfer side of provisioning station.

FIG. 8B: shows the tool storage device illustration of FIG. 8A rotated.

FIG. 9: shows a detailed view of the provisioning station's provisioning bar in the second position and pivoted together with the manipulator arm shortly before the tool change.

FIG. 10: shows an exemplary tool storage and machine tool system with automated mobile transport units for changing the respective tools between machine tool and tool storage device.

### DETAILED DESCRIPTION OF PREFERRED EMBODIMENTS

In the following, embodiments of the present invention are described in detail with reference to exemplary figures. The features of the embodiments may be combined in whole or in parts, and the present invention is not limited to the described embodiments.

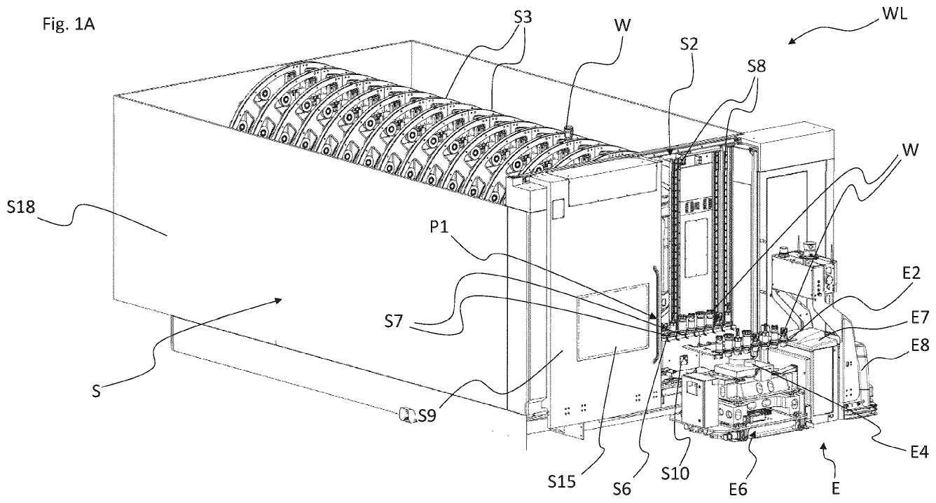

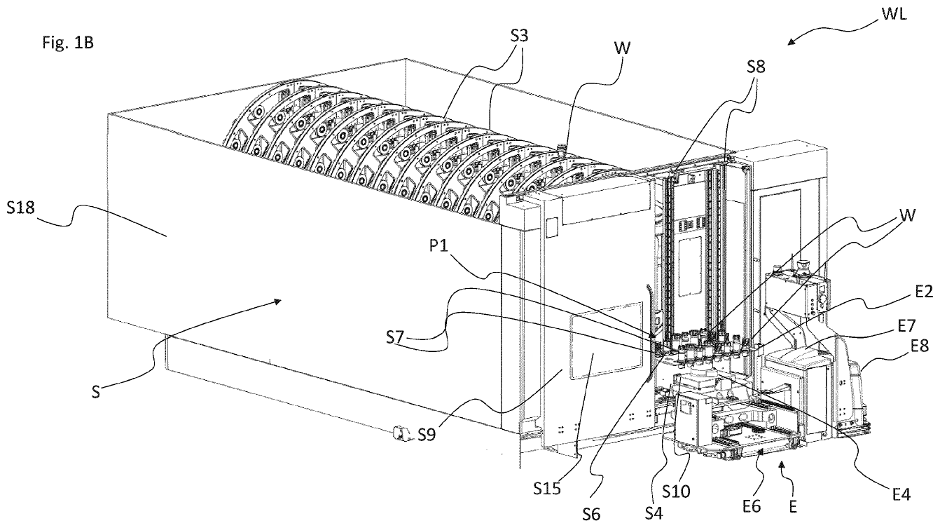

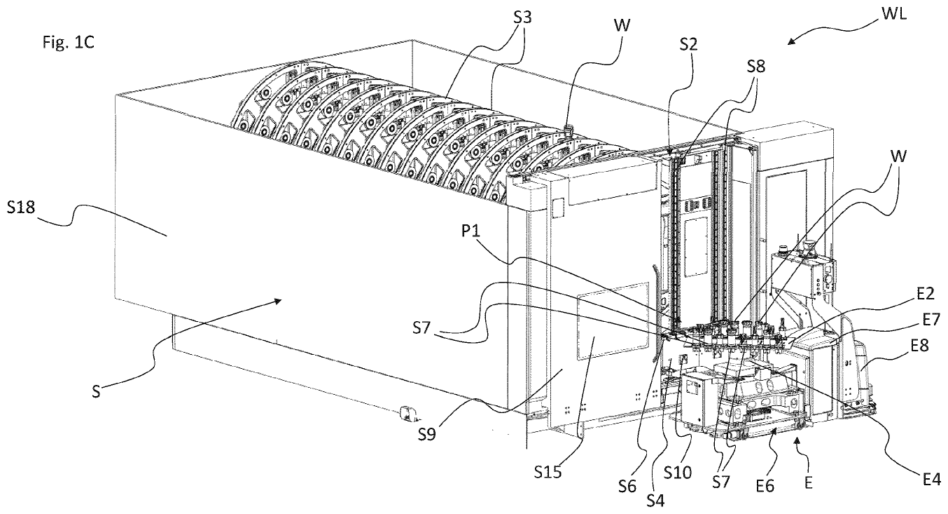

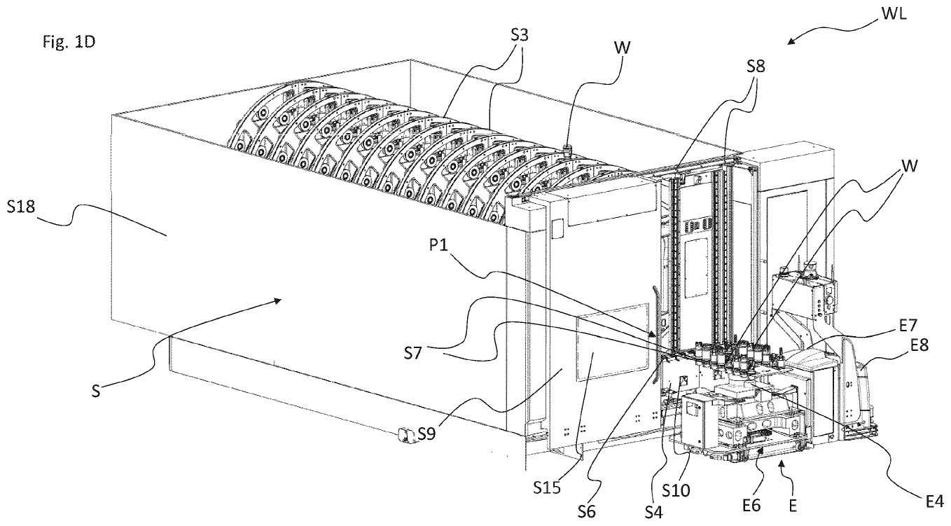

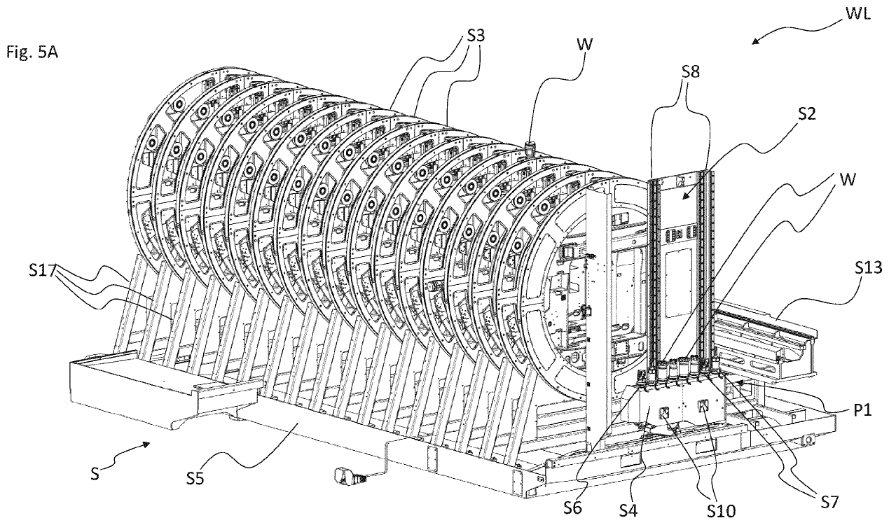

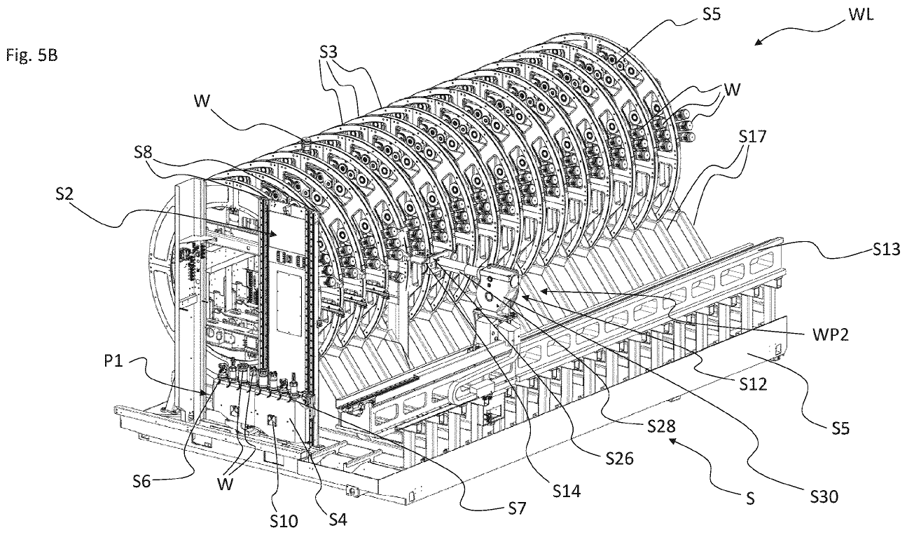

FIG. 1A shows the externally visible shape of a first embodiment of the tool storage device WL together with the tool storage S and an exemplary embodiment of the mobile transportation unit E. In this case, the tool storage S comprises a series of wheel magazines S3 arranged one behind another and rotatable independently of one another, which are enclosed from all sides by walls S18 fastened to a base frame S5 (cf. FIG. 5A) to protect workers. Within the wheel magazines S3, tools W can be inserted and removed in radially aligned tool holding locations by means of the manipulator S12 positioned next to the wheel magazines S3 (cf. FIG. 5B), wherein after insertion of the respective tool W in a tool holding location, at least its tool interface S7, in most cases also the tool head, is exposed in the wheel magazine S3 to ensure optimized accessibility of the latter. In addition, the wheel magazines S3 are arranged in parallel and one behind the other along their rotation axis, which makes it possible to realize a tool storage S that is as compact as possible.

Furthermore, at the front of the tool storage device, the provisioning station S2 is attached flush to the side walls of the tool storage device as a compact wall device, so that in particular the front wall of the tool storage device WL has a particularly stable shape. However, it should be pointed out that the shape of the provisioning station S2 shown in this embodiment does not have to follow the generally valid illustration or position of a provisioning station S2 to be realized later. For example, in another exemplary embodiment of the tool storage device WL, there may also be several provisioning stations S2 located at the front and rear sides, or these may also occupy only parts of the tool storage walls S18.

In the center of the provisioning station S2, and thus, directly in front of the respective wheel magazines S3 of the tool storage S, the provisioning bar S4 is positioned in an indentation recessed in the provisioning station S2 and adapted to the provisioning bar S4, wherein the latter can be optimally integrated into the provisioning station S2 and be enclosed from all sides by an additional sliding door S9. By this, the provisioning bar S4 is secured from any external influences, and it is also able to lock the entire area of the tool storage device WL, enclosed by the walls S18, by closing the indentation located in the provisioning station S2, and thus, especially during long waiting times, protect the tools W located in the tool storage devices S from dust or other residual materials generated near a machine tool WM. In addition, the sliding door S9 includes a door sensor device (not shown), preferably acting electrically or optically, so that the former can register the arrival or positioning of a mobile transport unit E in front of the provisioning station S2 so as to open and close automatically depending on the progress of the tool change process. Further, a viewing window S15 might be included, made of durable and, in particular, transparent material, such that even in closed cases the tools W to be provided can be inspected in detail.

In addition to the provisioning bar S4, two vertically aligned guide rails S8, represented by two linear guides attached to the upper and lower sides of the provisioning station S2, are mounted in the recess of the provisioning station S2, which are further connected to the provisioning bar S4, and thus, enable the latter one to move between a first, lower position P1 for tool changing with the mobile transport unit E and a second, higher position P2 for tool changing with the manipulator S12 for provisioning and storing a tool W. The guide rails S8 can be moved in the recess of the provisioning station S2. Furthermore, a position sensor system (not shown) integrated in the indentation makes it possible to analyze and, if necessary, to automate the movement of the provisioning bar S4, so that, for example, the position of the provisioning bar S4 for tool changing with the mobile transport unit E or with the manipulator S12 can be optimally adapted or coupled with further mechanisms.

On the provisioning bar S4 of FIG. 1A, which is located in the first position P1, the provisioning brackets S6 of the provisioning bar S4 can also be seen, which are arranged in a row and in which, according to this embodiment, eight different tools W can be positioned and be provided for pickup by the mobile transport unit E or by the manipulator S12 as an example. In this regard, the provisioning brackets S6 are specifically configured such that, similar to the tool holding locations of the wheel magazines, the interfaces S7 of the individual tools W (indicated by a black ring in FIG. 1A, for example) remain open at all times and remain contactable for removal by the mobile transport unit E and the manipulator S12, thereby enabling a simplified and error-free tool change process. Similarly, each of the provisioning brackets S6 also has an automatable, electrically or mechanically controllable holding device, so that the stored tools W are fixed rigidly within the provisioning brackets S6 of the provisioning bar S4, but can easily be released from their holder for removal by the mobile transport unit E or by the manipulator S12.

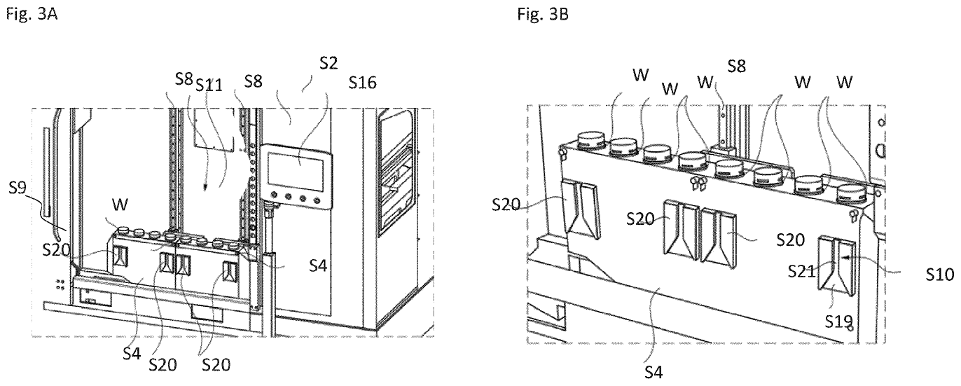

For positioning the mobile transport unit E to the provisioning station S2, two alignment sections S10 are attached to the provisioning bar S4. Exemplarily, both alignment sections S10 are provided with docking elements S20, S21 leading to a conical shape (cf. FIG. 3B), by means of which the alignment interfaces E11 of the mobile transport unit E can be positioned or be aligned in the simplest way by approaching and aligning them with the alignment sections S10. In addition, the attachment of the alignment sections S10 to the provisioning bar S4 has the particular advantage that the position of the docking elements can be adapted to the respective transport unit E by the vertical movement of the provisioning bar S4, which further simplifies the tool changing process and which can be made more cost-effective, due to the compatibility with a number of different mobile transport units.

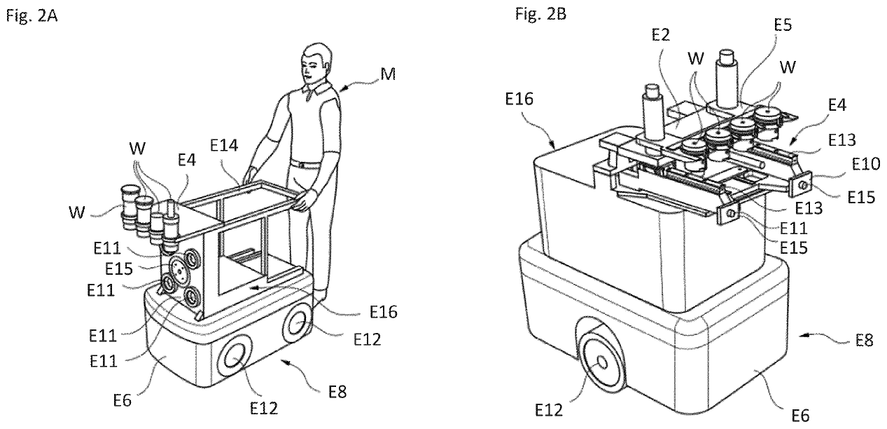

In contrast, the alignment interfaces E11 of the mobile transport unit E matching the alignment sections S10 are arranged in this exemplary embodiment on the transfer device E4, resting on two forks E6 of a driverless and automatable trackless floor conveyor E8 (e.g., a forklift truck or a lifting machine) (not visible in the figure, cf. FIG. 2B). In this case, the transfer device E4 is arranged in such a way that, first of all, it itself rests on a base body E16 directly connected to the forks E6 of the trackless floor conveyor E8 and can be moved one-dimensionally in the direction of the provisioning bar S4 via a guide rail directed toward the provisioning station S2 for the purpose of selectively aligning the alignment interfaces E11 on the alignment sections S10 of the provisioning station S2. In particular, the movement of the transfer device can preferably be controlled by a transfer control unit (not shown) integrated in the mobile transport unit E, so that approaching or positioning of the transfer device E4 to the provisioning bar S4 can preferably be carried out completely automatically for an optimized tool change.

A further transport and control unit E7 connected to the trackless floor conveyor enables the mobile transport unit E to be controlled via an external, manual or automated control system. In an extremely preferred example, this is also capable of receiving transport commands through an externally located server system, for example via radio, infrared signals, WLAN or similar interfaces, such that the external server system can preferably control the course of all mobile transport units E simultaneously, thus, realizing an extremely efficient transport process.

An exemplary removal process of a tool W by an aligned mobile transport unit E is furthermore shown in FIGS. 1A to 1D. In this case, the mobile transport unit E first moves, preferably operated by the transport and control unit E7, to the transfer position provided for the tool change and located along the provisioning station S2, the provisioning bar S4 of the provisioning station having preferably already been moved to its first position P1, as shown in FIG. 1A.

In the next step, as shown in FIG. 1B, the transfer device E4 is then moved along the aforementioned guide rail in the direction of the provisioning bar S4 until the respective alignment interfaces E11 are aligned with the alignment sections S10 of the provisioning station S2. For the removal of the tools W, two transport bars E2, which can be rotated and adjusted in the vertical direction, are thereby mounted on the transfer device E4 with a row of transport brackets corresponding to the provisioning bar S4, wherein the transport brackets include a gripping section E5 adapted to the respective tool interface S7 and an integrated clamping mechanism for gripping and fixing the removed tools. Furthermore, in this exemplary embodiment, the transport brackets of the transport bars E2 and the provisioning bracket S7 of the provisioning bar S4 are arranged to hold the tools W along their longitudinal axis in the vertical direction. The tool interfaces S7 of the tools W to be changed to be used for removal is positioned, in the case of the provisioning bar S4, at the lower end of the tool part exposed by the provisioning brackets S7.

In case the alignment interface E11 of the mobile transport unit E is positioned at the alignment section S10 of the provisioning station S2 (FIG. 1B), the transport bracket E2 is preferably moved together with the transport brackets (by prior vertical translation and rotation) in such a way that the gripping sections E5 of the individual transport brackets of one of the transport bars E2 have already moved flush into the exposed tool interfaces S7 of the tools W to be picked up during the alignment movement of the transfer device E4, now enclosing those to a larger extent, pincer-like. Preferably, the tool W can already be fixed in the transport bracket of the transfer device E4 by the clamping mechanism at this point, such that the former can already be safely transferred to the mobile transport unit E during the tool change.

Due to the resulting fixed contact of the gripping sections E5 of the transport bar E2, the tool W to be changed can subsequently be removed from the provisioning brackets S6 of the provisioning bar S4 by a simple vertical movement of the provisioning bar S4 (in other words, a lifting movement of the provisioning bar S4 relative to the transport bar E2). Thereby, the tool W rests on the gripping sections E5 of the transport bar E2 at the tool interfaces S7 at any time, such that a stable positioning of the tools W can be ensured, wherein, for example, the dimension/height of the lifting movement is defined by the geometry of the alignment section. In a preferred embodiment, moreover, the gripping sections E5 or the associated clamping mechanisms can be individually controlled in such a way that, depending on the choice of tools W to be removed, only individual tools W already present in the provisioning bar S4 can be removed, so that tools W for several mobile transport unit E can be present in the provisioning bar S4, offering optimized parallelization of the tool change process.

After the tools W have been removed, the guide rail attached to the transfer device E4 can then be used to move the transport bar E2 together with the removed tool W back in the direction of the mobile transport unit E, so that the transfer device E4 can be found again in an initial position or transport position at the end of the tool change process. FIGS. 1C and 1D show a possible exemplary embodiment in which, after the transfer device E4 has been moved back, the transport bars E2 have additionally been rotated clockwise, initially by 45° (FIG. 1C), up to an angle of 90° (FIG. 1D), and thus, the tool W is optimally positioned for transport to the machine tool WM. At the same time, it is of course also possible, especially in the case of two or more transport bars E2 contained on the transfer device E4, to add a tool W already removed from machine tools WM to the empty provisioning bar S4, for example by rotating the transport bar E2 to be used for this purpose in the direction of the provisioning station S2 and by approaching it again.

FIG. 2A shows a further embodiment of the mobile transport unit E, which was designed in particular for manual use. Unlike the embodiment shown in FIGS. 1A to 1D, this embodiment exemplary has a simplified and correspondingly lighter shape, so that a worker M can move the mobile transport unit W with ease and without the aid of further elements. Further for this purpose, in particular, a support bar E14 has been attached to the rear side of the mobile transport unit E, on which the respective worker M can support himself and push the mobile transport unit E in front of him.

Furthermore, in this exemplary embodiment, the body of the transfer device E4 is designed in such a way that it is provided solely as a guide plate resting on the base body E16 and as a two-dimensional guide plate, which is displaceable in the horizontal direction, to which four transport brackets E2 (embodiment shall not limited to four transport brackets) together with tools W have been attached at the front region here as an example. The positioning of the latter at the front of the mobile transport unit E fulfills the purpose here that the worker M can move the transport bars E2 more easily to the respective provisioning stations S2 tool storage devices, so that an optimized, and in particular a more precise tool change process can occur. Similarly, the alignment interfaces E11, here realized as four circularly adapted elements, as well as a further communication interface E15 for communication and exchange of exemplary tool data by means of electrical, optical or mechanical signals with the provisioning station S2 are also attached to the front of the base body E16, wherein the worker can position the mobile transport unit E extremely efficiently and precisely at the alignment sections S6 of the tool storage device WL, and, at the same time, transferring information about the tools W to be transferred or removed from the tool storage device S to the tool storage device WL is possible. Finally, the trackless floor conveyor E8 mounted beneath the base body E16 has been designed for efficient manual transport. Thus, for the safety of the worker, the base body of the floor conveyor E8 closes flush with the fork E6 connected to the base body as well as its tires E12, so that running over or crushing of body parts is made practically impossible.

FIG. 2B also shows another embodiment of the mobile transport unit E, which is designed as an automatically and as manually movable mobile transport unit E. In this case, the transport bar E2 to be used for holding the tools W is again seated on the transfer device E4, but can be moved independently of the transfer device E4 by guide rails E13 directed toward the front of the mobile transport unit E in the direction of the provisioning station S2 of the tool storage device WL. Furthermore, similar to the embodiment shown in FIGS. 1A to 1D, the alignment interfaces E11 are rigidly positioned on the transfer device E4, once more at the front, so that in this exemplary embodiment the mobile transport unit E as such must be moved to the alignment sections S10 of the tool storage device WL in order to realize a connection between the alignment section S10 and the alignment interface E11. The communication interfaces E15 to be used for data transmission have been implemented here in the same way, i.e., in the kind of a press-on button device attached to the alignment interfaces E11 with is pre-loaded by a spring.

Furthermore, the base body E16 and the floor conveyor E8 connected to the base body E16 have been optimally adapted for manual as well as for automatic transport of the tools. In this case, the base body E16 is attached as a closed body in which necessary electronic elements, such as the transport and control unit to be used for automated operation, can be efficiently stored. At the same time, the transfer device E4 has supports E18 on the upper side of the transport bar E2, on which the worker M can support himself and move the mobile transport unit E. In addition, the floor conveyor E8 is once again designed as a flush fit with the fork E6 and the wheels E12, so that the safety advantages already described come into play in this embodiment.

In addition, in this embodiment only two tires E12 connected to a stabilizing gear are provided so that the mobile transport unit E can also be tilted or connected at an angle for tool changing purposes, which provides an additional degree of freedom that can be easily designed. Preferably, the tires can be Mecanum wheels so that, for example, no additional axle needs to be used to steer the mobile transport unit E.

FIGS. 3A and 3B further show a detailed view of another embodiment of the provisioning bar S4, and the provisioning station S2 of the tool storage system WL, respectively. In this case, for a parallelized tool change with a plurality of mobile transport units E, several alignment sections S10 are attached to the provisioning bar S4, wherein the overall process can be optimized once again. In particular, in this exemplary embodiment, provided that two mobile transport units E to be positioned next to each other, each can remove at least four tools W from the provisioning bar S4 or can transfer them to it in parallel, wherein the number of mobile transport units E to be used simultaneously and tools W to be removed refer only to the exemplary embodiment shown here and are therefore not to be understood as generally valid.

For effective positioning of the respective mobile transport units E, a plurality of alignment sections, in the given case two for each mobile transport unit E to be operated, are attached to the provisioning bar S4 at regular intervals, so that the transport bars E2 of the respective mobile transport units E can interact with the provisioning bar S4 independently and without any contact with each other. A display S16 connected to the alignment sections S10 can display the status or tool data of the tools W stored in the provisioning holding sections S6, and display when and whether a mobile transport unit E is successfully connected to the provisioning station S2.

FIG. 3B further illustrates the structure of the alignment sections S10 of the provisioning bar S4 of FIG. 3A in more detail. As in FIGS. 1A-1D, each alignment section can have a funnel-shaped or conical inlet point S19 at their lower part, at which the alignment interface E11 of the mobile transport unit E can be inserted into the alignment section S10, and thus, block the movement of the mobile transport unit E along the provisioning station S2. The subsequent lifting movement during the removal or transfer of the tool W is a vertical lifting movement of the provisioning bar S4 of the provisioning station S2. Again, the funnel-shaped form of the alignment section S10 is solely to be understood as arbitrary example for positioning and securing the mobile transport unit E at the provisioning station S2. For example, other alignment sections S10 can be realized, which can also be attached to the provisioning bar S4 in a round or polygonal shape and which can fix the mobile transport unit E mechanically, exemplarily electrically, e.g., by induction or electromagnets, hydraulically or in pressure-controlled manner, e.g., by a suction/vacuum. In addition, it is possible to use the mobile transport unit E as shown, for example in FIGS. 1A to 1D. With such a transport unit, an alignment and positioning of the mobile transport unit can be performed without direct physical contact with the tool storage device. Contact can only occur during the actual transfer of the tools. Blocking the movement of the mobile transport unit E, e.g., for the tool transfer process, can be achieved without direct contact with the tool storage device, e.g., by blocking the wheels of the mobile transport unit positioned precisely in front of the tool storage device.

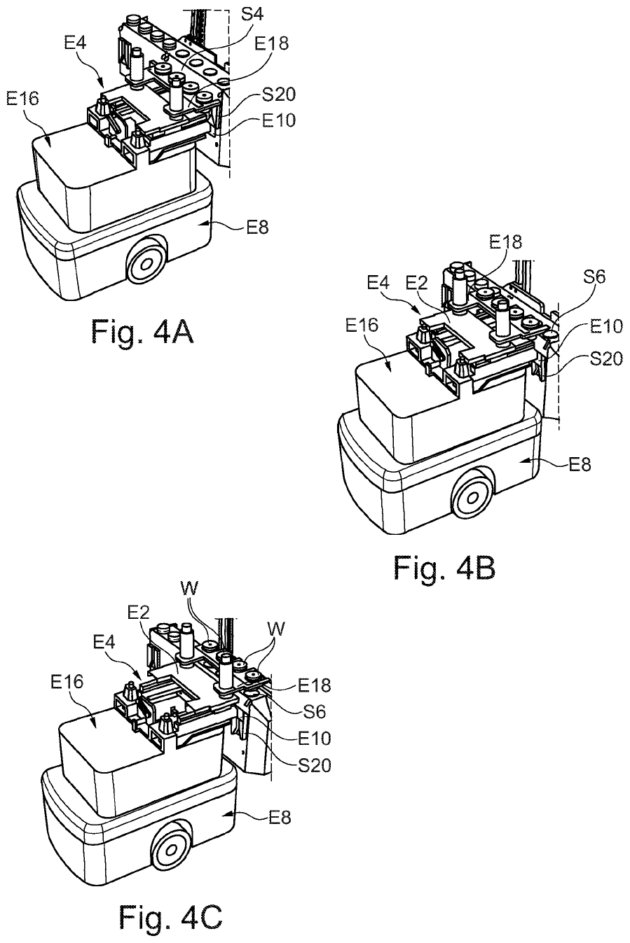

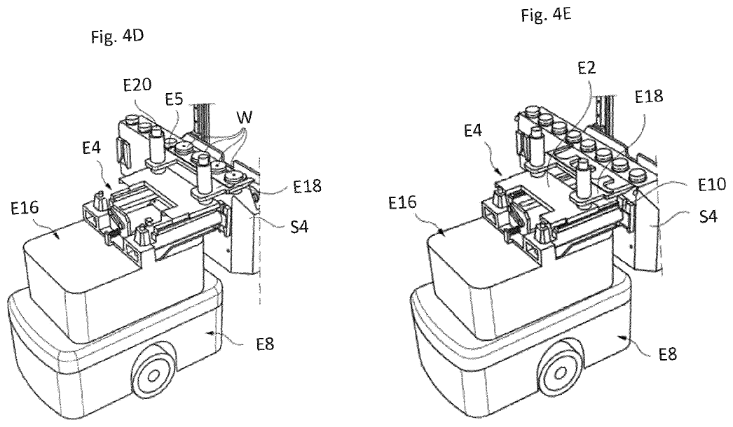

Further, FIGS. 4A to 4E show an exemplary transfer process of tools W with the mobile transport unit E shown in FIG. 2B and the provisioning bar S4 already shown in FIGS. 3A and 3B. As already shown in FIGS. 1A to 1D, the mobile transfer unit E first moves to the transfer position prescribed for the tool change, the former being positioned for this purpose frontally in front of the respective provisioning bar S4 and slowly approaching the latter until the alignment interfaces E10, attached to the front sides of the transfer device E4, preferably come into contact with the provisioning bar beneath the alignment sections S10 of the provisioning bar S4 (FIG. 1A).

As a result of the lowering of the provisioning bar S4, the transport bar E2 of the mobile transport unit E is raised relative to the provisioning bar S4 together with the alignment interface E11, so that the alignment interface E11 falls into the guide shape of the alignment section S10 and the movement of the mobile transport unit E is thus blocked from all sides (4B, for improved visualization, the alignment interface E11 is shown here in front of the alignment section S10). Furthermore, if the alignment interface E11 meets the upper end of the alignment section S10, the transport bar S2 cannot be moved down further either, so as the tools W to be transferred, wherein the lifting mechanism to be achieved is blocked by the shape and position of the alignment section S10, consequently being defined therethrough.

In the next step, the locked transport bar E2 is then moved by the guide rail E13 integrated in the transfer device E4 in the direction of the provisioning bar S4 until the tools W located in the transport brackets are precisely positioned above the empty provisioning brackets S6 of the provisioning bar S4 (FIG. 4C). Preferably, for precise positioning of the tools W, the transfer device E4 can also be configured in such a way that the transporting rail E2 was first moved to the rearmost position of the guide rail E13 to the provisioning bar S4 of the provisioning station S2, and by moving the transport rail E2 to the foremost position of the guide rail E13, the tools W are moved precisely over the provisioning brackets S6 of the provisioning bar S4. In another embodiment, movement and position sensors, for example optical infrared sensors or acoustic measuring sensors, can preferably be attached to the transport bar E2 in order to be able to determine the position of the tools W relative to the provisioning brackets S6 even more precisely.

After positioning the tools W via the provisioning brackets S6 of the provisioning bar S4, they are slowly inserted into the provisioning brackets S6 by lifting the provisioning bar S4 again (FIG. 4D) until they are no longer supported by the transport bracket of the transport bar E2 as the tool body is placed on the bottom of the respective transport bracket S6. Preferably, with an additional holding mechanism located in the transport bracket, the latter can also be released at this point by an integrated pressure mechanism or preferably also by the above-mentioned position sensor.

Since in this state the transport bracket or the gripping section E5 mounted therein is no longer loaded by the tools W, the transport bracket E2 can lastly be retracted without any difficulty with aid of the guide rail E13, while the tools W remain in the provisioning bar S4 (FIG. 4E). An additional lifting of the provisioning bar S4 additionally releases the alignment interface E11 of the transfer device E4 from the guide of the alignment section S10, wherein the mobile transport unit E becomes movable again and can initiate the next transfer or removal process.

FIG. 5A shows again the tool storage device of FIGS. 1A to 1D, but, in this case without the explicit illustration of the mobile transport unit E and the walls S18 arranged around the tool storage device S for protection. In particular, the compactness of the tool storage S can be seen in this form of illustration, which is realized in particular by the special mounting of the wheel magazines S3 arranged in a row and the frame structures associated therewith. In order to build a particularly compact and modular tool storage S, the wheel magazines S3 are mounted by means of three-point bearings on triangular frames S17 connected to the base frame S5 of the tool storage and aligned parallel to each other, wherein each wheel magazine S3 is interchangeably connected to this bearing and can be removed from it for easy exchange with other wheel magazines S3 or for repair.

Similarly, such a frame geometry has the advantage that the size of the individual wheel magazines S3 does not require a uniform size of the wheel magazines. Thus, contrary to the embodiment shown in FIG. 5A, for example, substantially smaller or larger wheel magazines S3 can also be inserted into the triangular frame S17 or its bearing or be interchanged with existing wheel magazines S3, as long as permitted by the size of the base frame S5, the walls S18 and the space estimated by the manipulator S12.

Furthermore, the frames S17 are designed in such a way that further frame structures, and thus, wheel magazines S3, can also be attached to the two ends of the respective tool storage, so that the tool storage S is in best case infinitely expandable. Thus, such a design achieves the maximum modularity of the tool storage, wherein the extremely compact and interconnected shape of the individual frame structures S17 allows the wheel magazines S3 to be positioned particularly efficiently and securely.

FIG. 5B shows the illustration of the central tooling device WL of FIG. 5A again, but, rotated by 90° in the horizontal plane. In particular, this illustration shows for the first time the manipulator S12, which is responsible for transporting the tools W between the tool magazines S3 and the provisioning bar S4, and which, in this embodiment, is located on a guide or running rail S13 aligned parallel to the rotation axis of the wheel magazines S3 and which can be moved along the wheel magazines S3 by this. Moreover, in this exemplary embodiment, the manipulator S12 has an extremely low-cost and efficient structure, in that only a rotatable gripping device S26, provided with a telescopic device S28 and aligned with a rotation axis along the telescopic device, together with two oppositely positioned manipulator brackets S14, similar to the transport brackets of the mobile transport unit E, are attached to the manipulator base body S30, which itself is connected to the running rail. The illustrated embodiment of the manipulator S12 represents only a selected example and may differ in other embodiments from what is shown herein. For instance, in other examples, the manipulator S12 may have more than one gripping device S26 or may move it transversely and rotationally in any direction by providing additional degrees of freedom. In other examples, the manipulator S12 may also move independently, for instance by means of a built-in motor, including a running axle and wheels, between the wheel magazines S3, thereby optimizing the movement possibilities of the former to a maximum.

In contrast, the illustrated embodiment of the manipulator S12 together with the running rail S13 prioritizes a form that is as cost-efficient as possible as well as time-efficient. Thus, the gripping device S26 attached to the manipulator S12 is preferably configured in such a way that, in its initial position, it is located at the level of the tools W horizontally supported by the wheel magazines S3 and, through its base, spans a surface orthogonal to the longitudinal axis of said tools W. In other words, the longitudinal axis of the gripping device S26 is at all times orthogonal to the horizontally supported tools W of the wheel magazines S3, so that it can remove the tool from the tool holding location of the respective wheel magazine S3 with a simple pulling movement of the telescopic device S28, after the tool interface S7 has been gripped by means of one of the manipulator supports S14.

For this reason, in order to remove or transfer a tool W from or to one of the wheel magazines S3 in this exemplary embodiment, the movement of the manipulator S12 together with the running rail S13 is preferably coupled to the rotation of the individual wheel magazines S3 via an automated system: Since the gripping device S26 in its initial position, in particular due to its proximity to the individual tools W stored in the wheel magazines S3, is set up in such a way that when the gripping device S26 is horizontally aligned, one of the manipulator brackets S14 can be inserted flush into the tool interfaces S7 of the respective tool W by approaching it laterally with the aid of the running rail. In a preferred embodiment, the wheel magazines S3 are initially moved automatically in such a way that, for tool changing at a specific tool holding location, a horizontal aisle is formed by unoccupied tool holding locations for the gripping device S26 of the manipulator S12. Subsequently, the gripping device S26, preferably aligned with the manipulator brackets S14 in the horizontal direction, can move through this aisle with the aid of the running rail S13 connected to the manipulator S12 and, for example, approach it to a so-called second change position WP2 for the removal of a horizontally mounted tool W. By the subsequent insertion of the respective tool W into the manipulator bracket S14, already described above, and the subsequent lifting movement by pulling the gripping device S26 towards the manipulator base body S30, a tool W can thus be removed from its tool holding location within a wheel magazine S3 and be transferred to the manipulator.

The reverse input of a tool W into a tool holding location, however, can be understood as a reversal of the removal process already described. By forming new aisles of free-standing tool holding locations, the manipulator location containing the tool W to be stored is first moved via the running rail S13 to the tool holding location intended for storage and already horizontally aligned. The respective gripping device S26 of the manipulator S12 in this case is retracted and locked in the direction of the manipulator base body S30 for securing the tool W. Arriving at the particular tool holding location at the second change position WP2, the tool W is then introduced into the tool holding location via the repeated extension of the telescopic device S28, or of the manipulator bracket S14 connected to the telescopic device S28, in the direction of the wheel magazines S3 until the entire cavity of the particular tool holding location is filled and the manipulator bracket S14 can be separated from the tool W by moving it again by means of running rail S13. Preferably, for more precise insertion of the tool W, a sensor, similar to the transfer device E4 of the mobile transport unit E, for example a pressure or position sensor, can also be attached to the manipulator S12, so that during the movement of the tool W in the direction of the wheel magazine S3, the current position of the tool W can preferably be compared with that of the tool holding location or an insertion stop can be executed if the manipulator S12 senses or experiences a certain counterpressure resulting from the restoring force of the tool holding location. Thus, such a sensor element has the positive effect of being able to make the tool change even gentler, and thus, safer, especially for fragile tools W.

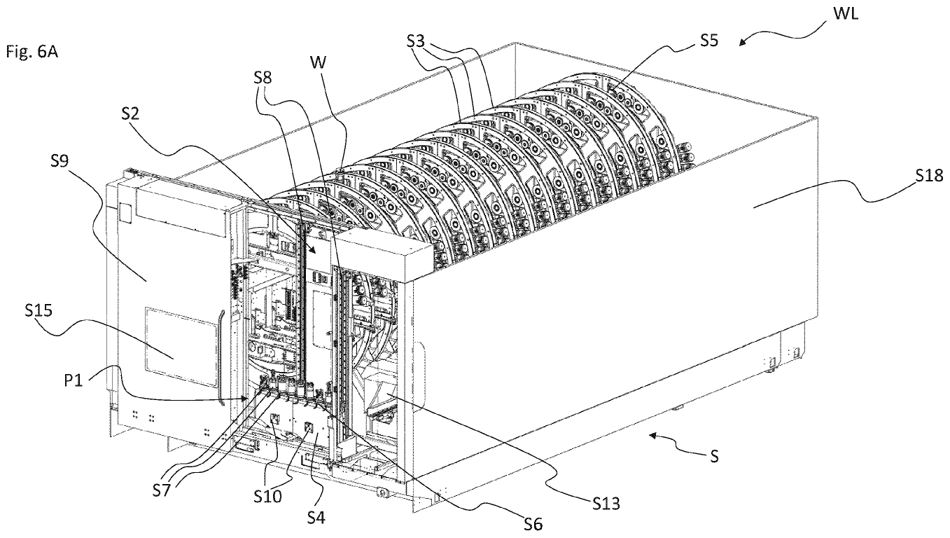

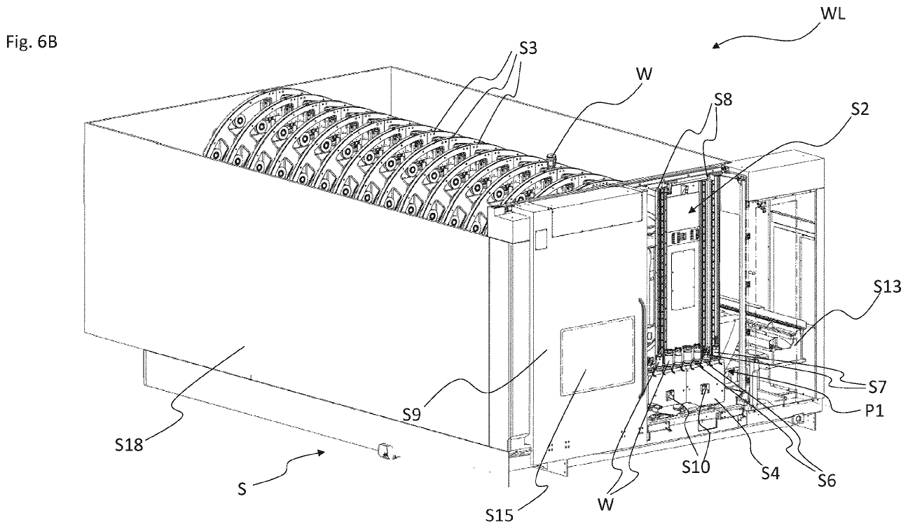

Further, FIGS. 6A and 6B show again the tool storage device WL of FIGS. 1A to 1D, wherein a partial section, more precisely the right wall section, of the provisioning station S2 removed or appearing transparent. In particular, it can be seen from this perspective that even in case of high, recessed tool storage walls S18, the indentation to be found in the provisioning station S2 and containing the provisioning bar S4 is not connected on all sides to the further construction of the provisioning station S2, but comprises an opening adapted to the provisioning bar S4 on both sides of the provisioning bar S4, in particular on the side facing the manipulator S12.

In this case, this opening is used in such a way that the provisioning bar S4 can be moved, at least initially with the aid of the vertically aligned guide rails S8, from the first position P1 for tool change, already mentioned, with the mobile transport unit E upwards to a second position P2a. There, it can additionally be pivoted by a certain transfer angle parallel to the provisioning station S2 at least in the direction of the manipulator S12 into a transfer position P2b. In other words, the openings thus allow direct contact between the provisioning bar S4 and the manipulator S12, which can be moved for this purpose by means of the running rail S13 to a first change position predetermined for the tool change.

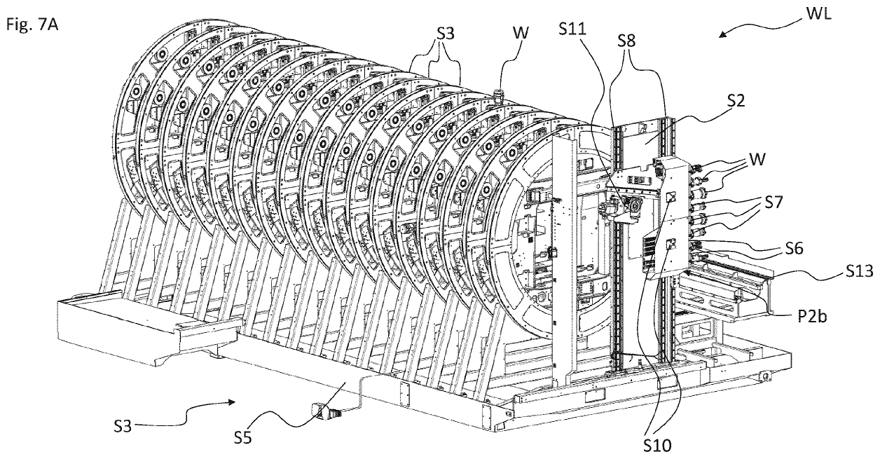

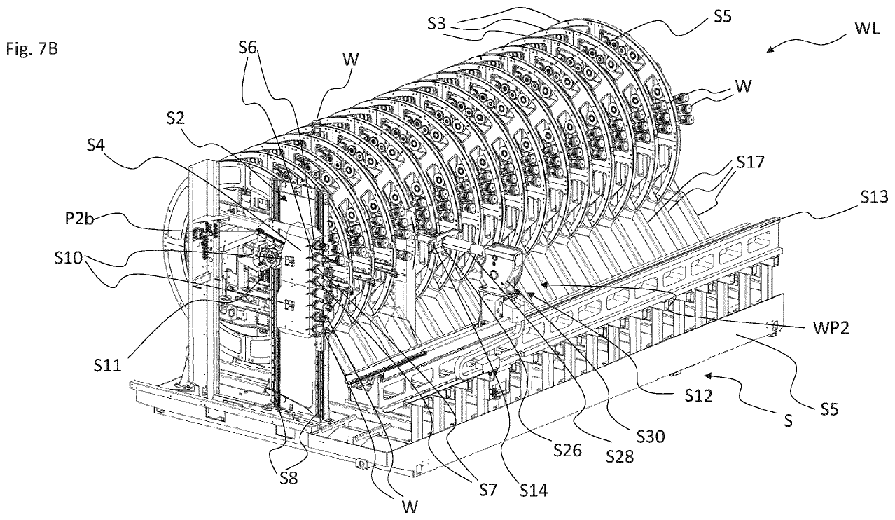

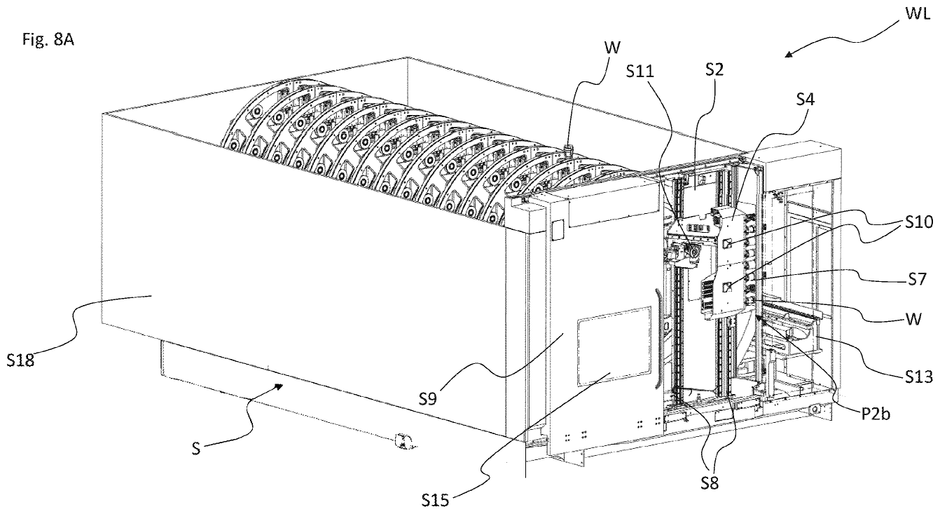

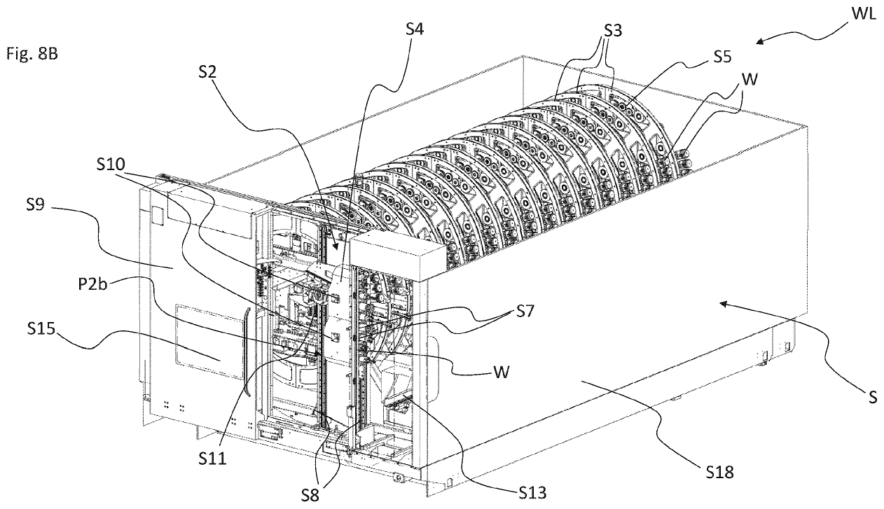

FIGS. 7A and 7B as well as 8A and 8B, in which likewise the previously described tool storage device WL is shown again with the provisioning bar S4 in the second, already pivoted position P2b, also called handover position P2b, with (FIGS. 8A and 8B) and without wall insert (FIGS. 7A and 7B), illustrate this handover process once again in more detail. Due to the geometrical differences of the tool supports between the provisioning station S4 and the manipulator support S14 (in the provisioning station S2 and the mobile transport unit E, the tool W is preferably supported vertically, whereas in the manipulator S12 it is supported horizontally), it is advantageous to adapt the tool orientation W to the respective tool storage device element to be transferred in an intermediate process, in order to provide optimal transfer conditions. In this embodiment, this is done by pivoting or rotating the provisioning bar S4 loaded with tools W into a handover position P2b intended for interaction with the manipulator S12.

For this purpose, a pivoting device S11, which is implemented by a radial bearing and can be controlled automatically, is attached to the provisioning bar S4 and can rotate the latter around a specific transfer angle via a pivoting arm connected to the provisioning bar S4, and thus, optimally align it with the manipulator S12. In this context, the pivoting device S11 is also designed in such a way that, in the handover position, the provisioning bar S4 P2b, in particular the tools W stored or to be stored on it, project into the lateral opening of the provisioning station S2 and are thus additionally protected by walls of the provisioning station S2. Thus, the pivoting of the provisioning bar S4 has the advantage to optimally align the respective tool W for the tool change with the manipulator S12 and to efficiently protect it from external influences, such as dust or residual products produced by machine tools WM.

Furthermore, the transfer angle of the provisioning bar defining the rotation or pivoting circumference can be accurately set by the pivoting device S11 depending on the setting of the manipulator S12. Thereby, in a preferred exemplary embodiment, this amounts to a rotation angle of 45° to 120°, in a particularly preferred exemplary embodiment even 80° to 110°, wherein the angle specification is to be understood as the rotation angle of the provisioning bar S4 generated by the pivoting device S11 from its original position, vertically aligned second position, to the handover position P2b or back.

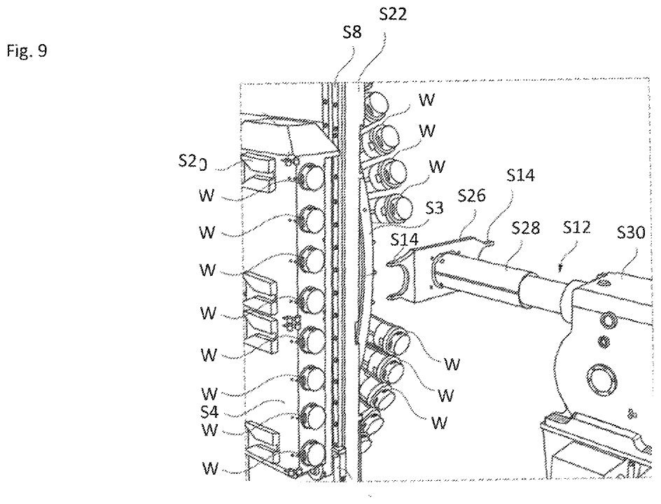

FIG. 9, meanwhile, shows an exemplary detailed illustration of the manipulator S12 near the first change position as well as parts of a wheel magazine S3 belonging to the tool storage S and the provisioning bar S4 in the handover position P2b, wherein the tool change between provisioning bar S4 and manipulator S12 can be demonstrated even more clearly. Here, the provisioning bar S4 in the handover position P2b is initially set up in such a way that the tools W, similar to those in the tool holding positions of the wheel magazines S3, are encompassed by moving the gripping device S26 of the manipulator S12 laterally towards the tools W by means of the manipulator brackets S14 at the tool interfaces S7. Thus, those can be removed from the provisioning bracket S6 via a horizontal lifting movement by retracting the gripping device S26 by means of the telescopic device S28. The resulting tool change process between manipulator S12 and provisioning bar S4 can thus be understood as approximately equivalent to the tool change process of the manipulator S12 with one of the wheel magazines S3.

For the approach of the manipulator S12 to the provisioning bar S4, all wheel magazines are first rotated again so that they form a path for the horizontally aligned gripping device S26 of the manipulator S12. Thereupon, the latter moves by means of the running rail S13 to the first change position provided for tool change, wherein, in case of tool removal, at least one of the vertically aligned tools W of the provisioning bar S4 located at the level of the gripping device S26 can be contacted by the manipulator bracket S14 at the tool interface and be removed according to the process already described before. Moreover, in this exemplary embodiment, the insertion of tools W into the provisioning brackets S6 of the provisioning bar S4 is also similar to the process already mentioned for describing the tool storage insertion, wherein the tool W contacted at the manipulator bracket S14 can safely and efficiently be inserted into the respective provisioning brackets via the approach of the previously retracted gripping device S26 in the direction of the provisioning bar S4.

Preferably, the provisioning bar S4 can also be configured in such a way that, in the handover position P2b, it can still be moved at least in its height by the vertically aligned guide rail S8, so that for optimized tool change the height required for removal or transfer with the manipulator S12 can be approached by each provisioning bracket S6, and thus, unnecessary, repeated pivoting for removal of different tools W from the provisioning bar S4 can be avoided.

Thus, the tool storage device WL shown here represents a simultaneously compact, simplified and efficient device for changing tools W, especially for a plurality of machine tools WM. Furthermore, the aforementioned elements of the tool storage device WL, as well as the tool changing and transport processes resulting therefrom, result in the serious advantage that the overall procedure for changing the tools W between the tool storage device WL and the machine tools WM associated therewith can be carried out completely automatically or at least semi-automatically, wherein maximum efficiency can be achieved, in particular with regard to a central tool storage system being spaced apart from a plurality of machine tools WM.

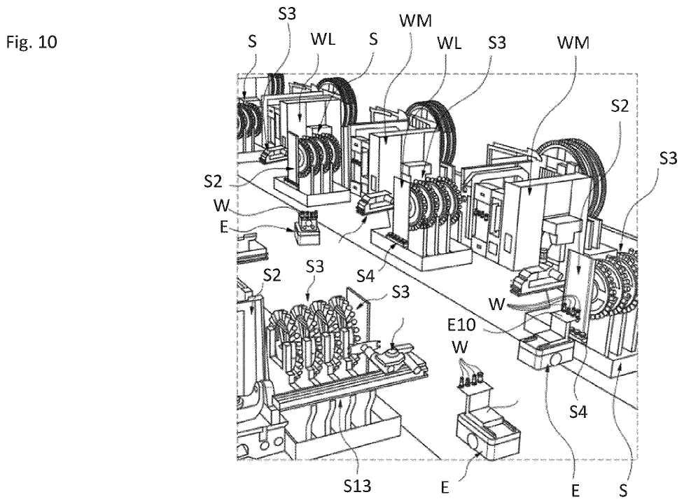

FIG. 10 shows a selected sketched example of such a possible tool storage system, in which both, central tool storage devices WL and machine tools WM connected to them via mobile transport units E, are used. As it can be seen in this particularly preferred embodiment, both, the machine tools WM and the tool storage devices WL are approached by mobile transport units E moving along a central transport line, wherein each mobile transport unit E can be moved independently from one destination to the next without rails and, above all, without any guidance. Thus, such a system avoids any waiting times caused by transport restrictions between tool storage WL and machine tool WM and also enables a maximally efficient, error-minimized and completely modular and continuously expandable system structure.

The automated control of the individual system elements is preferably carried out by an external server system, which can view the processes of the individual machine tools WM and control specific tool storage devices WL together with mobile transport units E via control units attached to the respective elements in such a way that the machine tools WM are operated optimally. For this purpose, for example, each tool storage S can also contain its own internal memory in which the current tool inventory of the tool storage can be recorded and can be made accessible to the external server system. Likewise, the server system can preferably have overwriting rights for these internal memories, update them and, in particular, by means of the information contained in the internal memory, control the wheel magazines S3 contained in the tool storage S, the manipulator S12 as well as the provisioning station S2 and at least one mobile transport unit E in such a way, that they can autonomously transfer a tool W from the tool storage S to the machine tool WM or back, e.g. after the above-mentioned tool change processes.

In a further embodiment, the alignment sections S10 of the provisioning stations S2 can also be used to exchange information with the machine tool WM or with the mobile transport unit E, thus, can be seen as an alternative or additional support to the external server system. Thus, it is preferably possible that by positioning the alignment interface E11 of the mobile transport unit E at the alignment section S10 of the tool storage device WL, and particularly by positioning at an alignment section at the machine tool WM, for example, tool data relating to the tools W, required by the machine tool WM, can be taken from the provisioning station S2 and likewise compared with the tool inventory located in the internal storage of the tool storage device S. By means of such an information exchange, the wheel magazines S3, the manipulator S12 as well as the elements of the provisioning station S2 and the mobile transport unit E can be controlled, preferably by the provisioning station S2, to take the tool W, required by the at least one machine tool WM, from the tool storage S and to add it automatically to the machine tool WM. Vice versa, a tool W to be stored by a machine tool WM can of course also be added to the tool storage S by an equally automated process, in which the provisioning station S2 adds the tool data obtained by positioning the mobile transport unit Eat the alignment section S10 to the tool inventory of the internal storage.

1. Central tool storage device configured for tool provisioning for a plurality of machine tools, comprising:
a tool storage for storing tools, the tool storage having at least two wheel magazines arranged vertically and one behind the other, and the each of the wheel magazines has tool holding locations for holding tools;
at least one mobile transport unit configured for transporting the tool from the central tool storage device to the machine tool and back,
at least one movable manipulator for removing and returning tools from the wheel magazines, and
at least one provisioning station for providing tools for the tool storage (S) and the mobile transport unit, wherein
for providing tools from the tool storage for a machine tool, the central tool storage device is configured such that the manipulator removes at least one tool and transfers it to the provisioning station, and the mobile transport unit removes the tool, which has been transferred by the manipulator, from the provisioning station, and wherein
for storing tools in the tool storage, the central tool storage device is configured such that the mobile transport unit transfers at least one tool to the provisioning station and the manipulator removes the transferred tool from the provisioning station and adds it to the tool storage.

2. Central tool storage device according to claim 1,
wherein the provisioning station comprises at least one alignment section for positioning the mobile transport unit at the provisioning station, wherein the at least one alignment section is connectable to an alignment interface, which is integrated in the mobile transport unit, and
wherein for positioning at the alignment section, the alignment section is configured to position the mobile transport unit in a transfer position.

3. Central tool storage device according to claim 1, wherein,
the mobile transport unit is freely movable and is configured to transport the tool from the central tool storage device to the at least one machine tool and back, and
the mobile transport unit has a control unit for controlling the mobile transport unit driverlessly and/or a communication device for wireless connection to an external control device.

4. Central tool storage device according to claim 1, wherein
the mobile transport unit comprises a transfer device for tool change with the provisioning station and a trackless floor conveyor with at least one receptacle, preferably like a fork, for receiving the transfer device, and
the transfer device is removably mounted on the floor conveyor.

5. Central tool storage device according to claim 1, wherein
the transfer device has a movable tool transport bar with a plurality of transport brackets for storing tools on the mobile transport unit and at least one gripping section for gripping the tool during the tool change, and within the transfer position of the mobile transport unit, the transfer device is movable at least in the direction of the provisioning station and preferably additionally in the vertical direction.

6. Central tool storage device according to claim 1, wherein
the provisioning station comprises a movable tool provisioning bar, and
the tool provisioning bar is movable from a first position for tool change with the mobile transport unit to a second position for tool change with the manipulator and back, and
at least within the second position, the tool provisioning bar is pivotable in the direction of the manipulator.

7. Central tool storage device according to claim 1, wherein
the movable tool provisioning bar comprises at least one provisioning bracket for positioning tools on the tool provisioning bar, and
the provisioning bracket includes a holding device which rigidly fixes the tool in the provisioning bracket and can release it again for removal of the tool, and
the provisioning bracket is configured to expose a tool interface on the tool for changing the tool via the mobile transport unit.

8. Central tool storage according to claim 1, wherein
the transfer device of the mobile transport unit is configured such that the gripping section of the transfer device for removing the tool from the tool provisioning bar encloses the tool at the tool interface and picks up the enclosed tool by a lifting movement of the tool provisioning bar and/or the tool transport bar at the tool transport bar, and
the gripping section of the transfer device for transferring the tool to the tool provisioning bar, positions the tool at the tool interfaces above the tool provisioning bar and delivers it to the provisioning bracket of the tool provisioning bar by means of a lifting movement of the tool provisioning bar and/or of the tool transporting bar.

9. Central tool storage device according to claim 1, wherein
the manipulator is movable at least from a first changing position for tool changing with the tool provisioning bar to a second changing position for tool changing with the wheel magazines and back, and
the manipulator is preferably movable from the first change position to the second change position and back by a guide rail arranged parallel to the rotation axis of the at least two wheel magazines.

10. Central tool storage device according to claim 1, wherein
at least in the second position, the tool provisioning bar is rotated by a transfer angle from an original position about a rotation axis orthogonal to the provisioning station into a handover position for providing the tool provisioning bar for the tool change with the manipulator, wherein
while starting from the original angle of the tool provisioning bar in the original position, the transfer angle is a rotation angle between 45° to 120°, preferably 80 ° to 110°, in the direction of the manipulator.

11. Central tool storage device according to claim 1, wherein
the at least two wheel magazines are mounted one behind the other and have a common rotation axis oriented orthogonally to the supply station, each wheel magazine can be rotated independently for removal and loading of tools,
for supporting the tools, each wheel magazine accommodates tools along the longitudinal axis of the tool in the radial direction, and preferably the wheel magazines are modularly interchangeable via a frame system, and the number of wheel magazines mounted one behind the other can be increased.

12. Central tool storage device according to claim 1, wherein
the at least one alignment section of the provisioning station is configured to fix the movement of the mobile transport unit via a mechanical connection, in particular along the provisioning station, for securing and positional alignment of the mobile transport unit at the provisioning station, wherein
the transfer device is released by fixing the mobile transport unit for moving in the direction of the provisioning station or the mobile transport unit is fixed during the moving of the transfer device in the direction of the provisioning station.

13. Central tool storage device according to claim 1, wherein
by connecting the alignment section to the alignment interface of the mobile transport unit or by a central server system, the provisioning station receives tool data relating to tools (W), which are required by at least one machine tool, and/or tool data relating to tools, which are transferred from the mobile transport unit, and the provisioning station is preferably configured to transfer the received tool data to an internal data memory; and/or wherein
the provisioning station is configured to compare received tool data with a tool inventory of the tool storage device, preferably contained in the internal data memory, and
upon finding a required tool in the tool inventory of the tool storage device, the provisioning station controls the wheel magazine containing the required tool, the manipulator and the receiving section of the provisioning station to transfer the required tool from the wheel magazine to the mobile transport unit, and
the provisioning station includes tool data of tools received by the mobile transport unit into the tool inventory and controls the wheel magazines, the manipulator and the receiving section of the provisioning station to insert the received tool into the tool holding locations of the wheel magazines.

14. The central tool storage device of claim 1, wherein tools are provided for a plurality of machine tools by means of the central tool storage device according to a method comprising the steps of:
Transferring a tool by the manipulator from a tool holding location of a wheel magazine to the tool provisioning bar of the provisioning station;
Transferring the tool from the tool provisioning bar to the mobile transport unit; and
Transporting the tool by means of mobile transport unit from the central tool storage device to at least one of the machine tools.

15. The central tool storage device of claim 1, wherein storage of tools from a plurality of machine tools are centralized by means of a central tool storage device according to a method comprising the steps of:
Transporting a tool by the mobile transport unit from at least one of the machine tools to the central tool storage device;
Transferring the tool from the mobile transport unit to the tool provisioning bar of the provisioning station; and
Transferring the tool by the manipulator from the tool provisioning bar to the tool holding location of a wheel magazine.

16. The method according to claim 15, further comprising the steps of:
Rotating the tool provisioning bar of the provisioning station to change the tool with the manipulator at the second position in the direction of the manipulator;
Positioning or removing the mobile transport unit from the alignment section of the provisioning station; and
Acquisition of the tool data of the tools transferred from or picked up by the tool storage and transfer of the tool data to a data memory.

17. The central tool storage device of claim 1, wherein the central tool storage device and at least one machine tool from the plurality of machine tools are part of a production system,
wherein for providing tools for the at least one machine tool, the central tool storage device is configured to remove a tool from the tool storage device and to transfer it to a mobile transport unit via the provisioning station, and
the mobile transport unit is positionable at the tool storage device and at the machine tool and is configured to transport the received tool to the at least one machine tool and to transfer it to the machine tool, and
wherein for storing tool from the at least one machine tool into the central tool storage device, the central tool storage device is configured to remove a tool from the at least one machine tool by the mobile transport unit and, to transfer it to the provisioning station of the tool storage device after the tool is transported by the mobile transport unit to the tool storage device, and
to remove the tool from the provisioning station and to transfer it to the tool storage.
